(19) United States
(12) Patent Application Publication
(10) Pub. No.: US 2015/0256964 A1
(43) Pub. Date: Sep. 10, 2015

(54) VIRTUAL BLUETOOTH DEVICE

(71) Applicant: Christopher Anthony SILVA, Manahawkin, NJ (US)

(72) Inventor: Christopher Anthony SILVA, Manahawkin, NJ (US)

(21) Appl. No.: 14/201,326

(22) Filed: Mar. 7, 2014

(51) Int. Cl. H04W 4/00; H04W 76/02

(52) U.S. Cl. CPC H04W 4/008; H04W 76/02

(57) ABSTRACT

The present invention is a system and method for providing a virtual Bluetooth device on an existing hardware device, such as a mobile phone. The virtual Bluetooth device appears at the interface of the hardware device as if an external physical Bluetooth device is connected. The virtual Bluetooth device can communicate with the hardware device's existing audio interfaces, such as a speaker and microphone, to capture and transmit audio and broadcast the received audio, just as an actual, physical Bluetooth headset would use its own speaker and microphone. The Bluetooth virtual device can also collect and store data that is transmitted and received from the virtual Bluetooth device.

### BACKGROUND OF THE INVENTION

1. Field of the Invention

The present invention relates to a system and method for generating a virtual Bluetooth device at an existing hardware device, such as a mobile phone.

2. Description of Related Art

It is known that Bluetooth communicators providing wireless communications according to the specifications of Bluetooth are used widely. Bluetooth can provide wireless control of and communication between a mobile phone and a hands-free headset.

U.S. Pat. No. 8,433,245 describes a multi-function compatible short-range wireless communicator which is capable of providing a plurality of connections at a time.

It is desirable to virtually provide the functionality of Bluetooth communications on existing hardware devices, such as a mobile phone.

### SUMMARY OF THE INVENTION

The present invention is a system and method for providing a virtual Bluetooth device on an existing hardware device, such as a mobile phone. The virtual Bluetooth device provides an interface to the user for Bluetooth communications at the hardware device. The virtual Bluetooth device appears at the interface of the hardware device as if an external physical Bluetooth device is connected. The virtual Bluetooth device can communicate with the hardware device's existing audio interfaces, such as a speaker and microphone, to capture and transmit audio and broadcast the received audio, just as an actual, physical Bluetooth headset would use its own speaker and microphone. Accordingly, the virtual Bluetooth device can act as a Bluetooth headset.

The Bluetooth virtual device can also collect and store data that is transmitted and received from the virtual Bluetooth device. In one embodiment, a plurality of virtual Bluetooth devices can be connected simultaneously in a multi-device environment. The virtual Bluetooth device is able to connect in the same multi-device environment and allow for data collection on the hardware device of any transmission to or from a virtual Bluetooth device or an actual Bluetooth device.

The invention will be more fully described by reference to the following drawings.

### BRIEF DESCRIPTION OF THE DRAWINGS

FIG. 1 is a schematic diagram of a virtual Bluetooth device in accordance with the teachings of the present invention.

FIG. 2 is a schematic diagram of a system of communicating with a plurality of virtual Bluetooth devices in a multi-device environment.

FIG. 3 is a flow diagram of a method for communicating using a virtual Bluetooth device in accordance with the teachings of the present invention.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

Virtual Bluetooth device 10 uses hardware device 12 implementing virtual Bluetooth device module 14. Hardware device 12 can be a mobile phone, such as a smartphone. Alternatively, hardware device 12 can be a personal digital assistant (PDA) or mobile internet device (MID) and the like.

Hardware device 12 includes operating system 15 which can interact with libraries 16. Operating system 15 can be implemented using CPU 11 of hardware device 12. Suitable operating systems for a mobile phone include Android™, Symbian®, Apple iOS™, RIM BlackBerry®, MeeGo®, Windows® Phone and Bada. Hardware device 12 includes hardware 20, such as microphone 22 and speaker 21. Hardware 20 can be integral with hardware device 12.

Virtual Bluetooth device module 14 utilize functions and applications of operating system 15 and/or libraries 16 to establish and maintain a virtual Bluetooth communication connection. Virtual Bluetooth interface module 17 generates a Bluetooth interface which can be displayed on display 19 of hardware device 12 and can be used to access the virtual Bluetooth communication connection.

Audio stream 23 to and from microphone 22 and speaker 21 can be captured and transmitted by virtual Bluetooth device module 14 to broadcast the received audio, thereby providing Bluetooth communications. For example, audio stream 23 can be pulse code modulation (PCM) packets. Audio data of audio stream 23 can be compressed into a waveform or similar digital audio file in audio format. Thereafter, audio stream 23 can be returned to its original function using virtual Bluetooth device module 14 and forwarded to microphone 22 and speaker 21.

Virtual Bluetooth device module 14 can store audio captured from audio stream 23 in memory 18 of hardware device 12. In one embodiment, Virtual Bluetooth device module 14 is a call recording application that can store in memory 18 the audio stream or pulse code modulation (PCM) packets from a call made with hardware device 12. Alternatively, Virtual Bluetooth device module 14 can store audio captured from audio stream 23 in external memory 25. For example external memory 25 can be a database. Virtual Bluetooth device module 14 can include software for digital watermarking, fingerprinting and encryption of the audio stream or PCM packets.

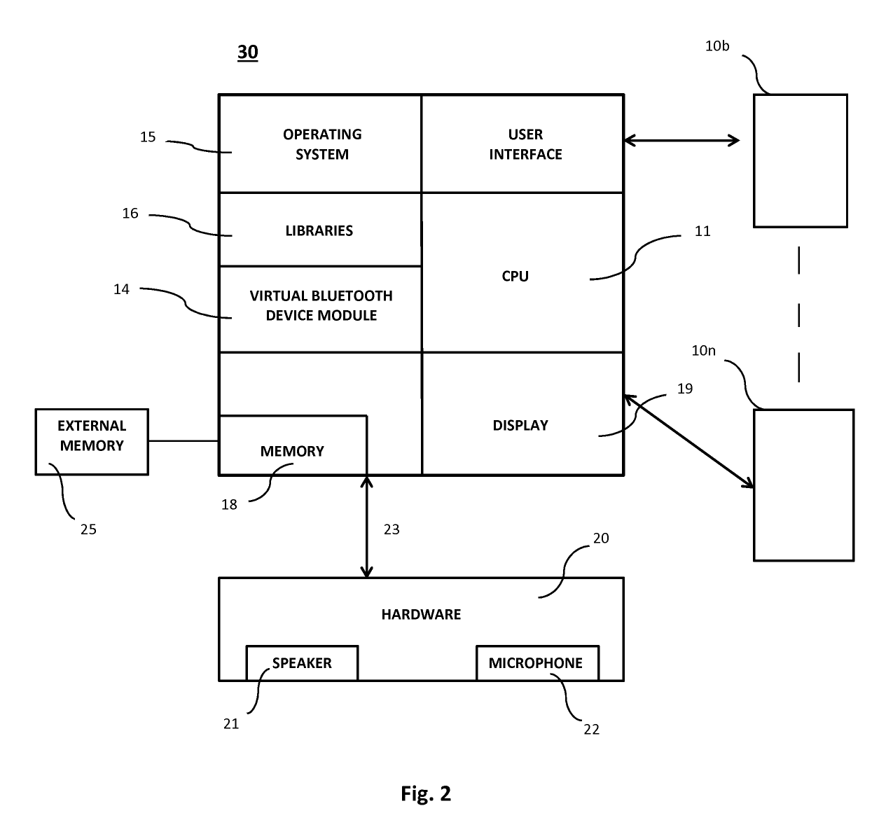

FIG. 2 is a schematic diagram of a multi-device environment 30. A plurality of Virtual Bluetooth devices 10a-10n communicate using wireless data network 32. Each of virtual Bluetooth devices 10a-10n is able to connect in the same multi-device environment and allow for data collection on the hardware device of any transmission to or from a virtual Bluetooth device 10a-10n or an actual Bluetooth device.

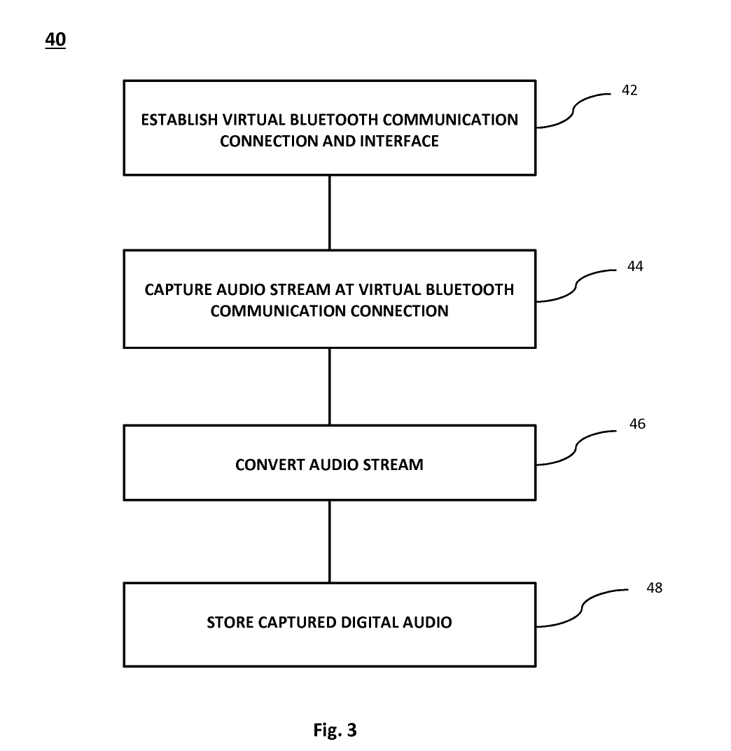

FIG. 3 is a schematic diagram of a method of communicating on a hardware device 40. In block 42, a virtual Bluetooth communication connection and virtual Bluetooth interface is established at the hardware device. In block 44, the virtual Bluetooth interface is used to activate the capturing of an audio stream for the hardware device at the virtual Bluetooth communication connection. In block 46, the audio stream is compressed into a waveform or similar digital audio file. In block 48, the captured digital audio file is stored.

Embodiments of the present invention may be implemented in connection with a special purpose or general purpose telecommunications device that include both hardware and/or software components, including wireless telephones and other telephony-enabled wireless devices, landline telephones, or special purpose or general purpose computers that are adapted to have telecommunications capabilities.

Embodiments may also include physical computer-readable media and/or intangible computer-readable media for carrying or having computer-executable instructions, data structures, and/or data signals stored thereon. Such physical computer-readable media and/or intangible computer-readable media can be any available media that can be accessed by a general purpose or special purpose computer. By way of example, and not limitation, such physical computer-readable media can include RAM, ROM, EEPROM, CD-ROM or other optical disk storage, magnetic disk storage or other magnetic storage devices, other semiconductor storage media, or any other physical medium which can be used to store desired data in the form of computer-executable instructions, data structures and/or data signals, and which can be accessed by a general purpose or special purpose computer. Within a general purpose or special purpose computer, intangible computer-readable media can include electromagnetic means for conveying a data signal from one part of the computer to another, such as through circuitry residing in the computer.

When information is transferred or provided over a network or another communications connection (either hardwired, wireless, or a combination of hardwired or wireless) to a computer, hardwired devices for sending and receiving computer-executable instructions, data structures, and/or data signals (e.g., wires, cables, optical fibers, electronic circuitry, chemical, and the like) should properly be viewed as physical computer-readable mediums while wireless carriers or wireless mediums for sending and/or receiving computer-executable instructions, data structures, and/or data signals (e.g., radio communications, satellite communications, infrared communications, and the like) should properly be viewed as intangible computer-readable mediums. Combinations of the above should also be included within the scope of computer-readable media.

Computer-executable instructions include, for example, instructions, data, and/or data signals which cause a general purpose computer, special purpose computer, or special purpose processing device to perform a certain function or group of functions. Although not required, aspects of the invention have been described herein in the general context of computer-executable instructions, such as program modules, being executed by computers, in network environments and/or non-network environments. Generally, program modules include routines, programs, objects, components, and content structures that perform particular tasks or implement particular abstract content types. Computer-executable instructions, associated content structures, and program modules represent examples of program code for executing aspects of the methods disclosed herein.

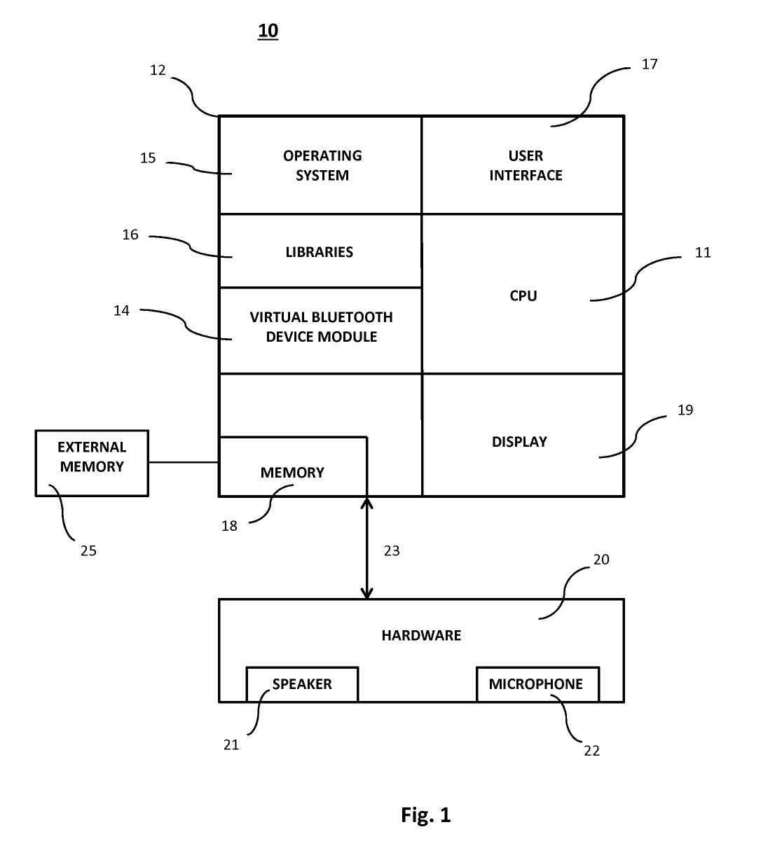

Embodiments may also include computer program products for use in the systems of the present invention, the computer program product having a physical computer-readable medium having computer readable program code stored thereon, the computer readable program code comprising computer executable instructions that, when executed by a processor, cause the system to perform the methods of the present invention. For example, in an embodiment, the invention provides a program product stored on a computer-readable medium, which when executed, enables a computer infrastructure to establish a virtual Bluetooth communication connection and interface. To this extent, the computer-readable medium includes program code, such as virtual Bluetooth device module 19 (FIG. 1), which implements the process described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, and/or as a data signal traveling over a network (e.g., during a wired/wireless electronic distribution of the program product)

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A method of communicating comprising the steps of:
establishing a virtual Bluetooth communication connection on a hardware device; and
capturing an audio stream received at the hardware device with the virtual Bluetooth communication connection.

2. The method of claim 1 further comprising the step of:
displaying a virtual Bluetooth interface on the hardware device and accessing said virtual Bluetooth communication connection with said virtual Bluetooth interface.

3. The method of claim 1 further comprising the steps of:
converting said audio stream into a digital audio file and storing said digital audio file.

4. The method of claim 3 wherein said digital audio file is stored on said hardware device.

5. The method of claim 3 wherein said digital audio file is stored remotely of said hardware device.

6. The method of claim 1 wherein the audio stream is pulse code modulation audio.

7. The method of claim 1 wherein said hardware device is a mobile phone and said audio stream is captured at a microphone or speaker of said mobile phone.

8. A method of communicating comprising the steps of:
establishing a virtual Bluetooth communication connection on at least one hardware device;
establishing a wireless network between a plurality of said hardware devices; and
capturing an audio stream received at the at least one hardware device with the virtual Bluetooth communication connection.

9. The method of claim 8 further comprising the step of:
displaying a virtual Bluetooth interface on the at least one hardware device and accessing said virtual Bluetooth communication connection with said virtual Bluetooth interface.

10. The method of claim 8 further comprising the steps of:
converting said audio stream into a digital audio file and
storing said digital audio file.

11. The method of claim 10 wherein said digital audio file is stored on the at least one hardware device.

12. The method of claim 10 wherein said digital audio file is stored remotely of the at least one hardware device.

13. The method of claim 8 wherein the audio stream is pulse code modulation audio.

14. The method of claim 8 wherein the at least one hardware device is a mobile phone and said audio stream is captured at a microphone or speaker of the at least one mobile phone.

15. A system for communicating audio of a mobile phone comprising:
a virtual Bluetooth module in a library communicating with an operating system of a hardware device to create a virtual Bluetooth communication connection, the virtual Bluetooth module receiving an audio stream received and/or sent by the microphone and/or speaker of the hardware device.

16. The system of claim 15 further comprising a virtual Bluetooth interface displayed on the hardware device and accessing said virtual Bluetooth communication connection with said virtual Bluetooth interface.

17. The system of claim 15 wherein the virtual Bluetooth module converts said audio stream into a digital audio file and further comprising memory at the hardware device for storing said digital audio file.

18. The system of claim 15 wherein said hardware device is a mobile phone and said audio stream is captured at a microphone or speaker of said mobile phone.

19. A computer program product for communicating using a hardware device, comprising: computer usable program code embodied in a non-transitory computer readable medium, which when executed by an operating system of the hardware device causes the operating system to: establish a virtual Bluetooth module, the virtual Bluetooth module providing a virtual Bluetooth communication connection, and capture an audio stream received at the hardware device with the virtual Bluetooth communication connection.

20. The computer program product of claim 19 wherein the virtual Bluetooth module converts said audio stream into a digital audio file and the computer usable program code when executed stores said digital audio file in memory at the hardware device.
